(19) United States
(12) Patent Application Publication
(10) Pub. No.: US 2002/0126894 A1
(43) Pub. Date: Sep. 12, 2002

(54) Stand type image scanner capable of performing drop-out processing

(76) Inventors: Satoshi Segawa, Kanagawa (JP); Tohru Shimizu, Tokyo (JP)

Correspondence Address: SUGHRUE, MION, ZINN, MACPEAK & SEAS, 2100 Pennsylvania Avenue, N.W., Washington, DC, 20037-3202, US

(21) Appl. No.: 09/736,297

(22) Filed: Dec. 15, 2000

(30) Foreign Application Priority Data
Dec. 15, 1999 (JP) 355872/1999

(51) Int. Cl. G06K 9/20; G06K 9/34; G06K 7/00; H04N 1/04

(52) U.S. Cl. 382/176; 382/163; 382/164; 382/312; 358/475; 358/509

(57) ABSTRACT

In a stand type image scanner, an exclusive light source portion is used in irradiation in which the light intensity in a specific wavelength band W within a wavelength band W0 in which the reflectivity of a portion to be dropped out on the original is higher than that in the other wavelength band, and a scanning portion performs binary processing of regarding as white color a portion of the original at which the detection value of reflected light intensity is higher than a reference value while regarding as black color a portion of the original at which the detection value of the reflected light intensity is smaller than the reference value.

### BACKGROUND OF THE INVENTION

The present invention relates to a stand type image scanner in which an original that is a scanning target and a scanning portion are disposed to be spaced from each other, in particular, to a stand type image scanner for performing such drop-out processing that portions which are represented with specific colors such as colored frames or the like in the image of the original are selectively prohibited from being scanned.

A sheet feeding type image scanner using a linear image sensor as a photoelectric conversion element has been particularly popularly used as an image scanner. However, in the sheet feeding type image scanner, the original as the scanning target is limited to cut papers which are Individually actually independent of one another, a so-called cut sheet type paper.

Therefore, a stand type image scanner has been practically used as a device which can scan a thick original and plural originals placed on a file. According to this stand type image scanner, a scanning portion containing a photoelectric converting element such as an image sensor or the like is disposed to be spaced from the face of the original by a fixed distance by a supporting portion such as an arm or the like. An example of such stand type image scanner is disclosed in Japanese Laid-open Patent Publication No. Tokkai Hei-11-098327 (Document 1). Further, a stand type image scanner having an exclusive light source for irradiating the face of the original is disclosed in Japanese Patent No. 2897814 (Document 2).

There is known a conventional sheet feeding type image scanner having a function of dropping out a specific color by setting the wavelength characteristic of an exclusive light source installed therein. The drop-out function is a convenient function which is effectively applied to such a case where only characters on an original image are selectively scanned by removing frame lines in the original image and the coloring of the background of the original image, for example, when an image scanning operation is carried out by an optical character recognizing device (OCR device).

However, in a stand type image scanner having no exclusive light source, as in the case of the document 1, it is a general manner that an original is exposed to environmental light emitted from a ceiling lamp or the like and the image of the original is scanned on the basis of the reflection light of the environmental light from the original. Therefore, it is difficult to irradiate the original with light having a specific wavelength characteristic. As a result, it is difficult to perform the drop-out processing in the stand type image scanner having no exclusive light source.

Further, the document 2 also never suggests that the drop-out processing is carried out by setting the wavelength characteristic of the exclusive light source.

### SUMMARY OF THE INVENTION

It is an object of this invention to deal with disadvantages mentioned above and to therefore provide a stand type image scanner and a method which can perform drop-out processing.

The other object, features, and advantages of this invention will become clear as the description proceeds.

This invention is directed to a stand type image scanner comprising an exclusive light source portion for illuminating an original as a scanning object to be scanned and a scanning portion for detecting reflected light from the original to scan an original image. The exclusive light source portion applies light having a light intensity in a specific wavelength band within a wavelength band where the reflectivity of a portion to be dropped out on the original is high is higher than that in an unspecific wavelength band. The scanning portion performs binary processing so as to regard a portion of the original where detection value of reflected light intensity is higher than a reference value as white color while regard a portion of the original where the detection value of the reflected light intensity is smaller than the reference value as black color.

### BRIEF DESCRIPTION OF THE DRAWINGS

FIG. 1A is a perspective view showing the construction of a stand type image scanner according to a first embodiment, and FIG. 1B is a perspective view showing the construction of an exclusive light source portion of the image scanner;

FIG. 2A shows an example of an original to be scanned, and FIG. 2B shows an example of an original image thus scanned;

FIG. 3A is a graph showing the wavelength characteristic of reflectivity at each part of the original, and FIG. 3B is a graph showing the wavelength characteristic of the light intensity of light emitted from the exclusive light source;

FIG. 4A is a graph showing the wavelength characteristic of reflectivity of a portion to be dropped out, and FIG. 4B is a graph showing the wavelength characteristic of the light intensity of light emitted from the exclusive light source;

FIG. 5A is a graph showing the wavelength characteristic of illuminance of a portion of the original to be dropped out, FIG. 5B is a graph showing the wavelength characteristic of sensitivity of an image sensor, and FIG. 5C is a graph showing the wavelength characteristic of the intensity of detected light;

FIG. 6A is a graph showing the wavelength characteristic of reflectivity of a portion to be dropped out, FIG. 6B is a graph showing the wavelength characteristic of the light intensity of environmental light, and FIG. 6C is a graph showing the wavelength characteristic of the light intensity of the exclusive light source;

FIG. 7A is a graph showing the wavelength characteristic of the illuminance of a portion of the original to be dropped out, FIG. 7B is a graph showing the wavelength characteristic of the sensitivity of the image sensor, and FIG. 7C is a graph showing the wavelength characteristic of the intensity of detected light; and

FIG. 8 is a perspective view showing the construction of a stand type image scanner according to a third embodiment of the present invention.

### DESCRIPTION OF THE PREFERRED EMBODIMENTS

Preferred embodiments according to the present invention will be described with reference to the accompanying drawings.

### First Embodiment

First, the construction of a stand type image scanner according to a first embodiment will be described.

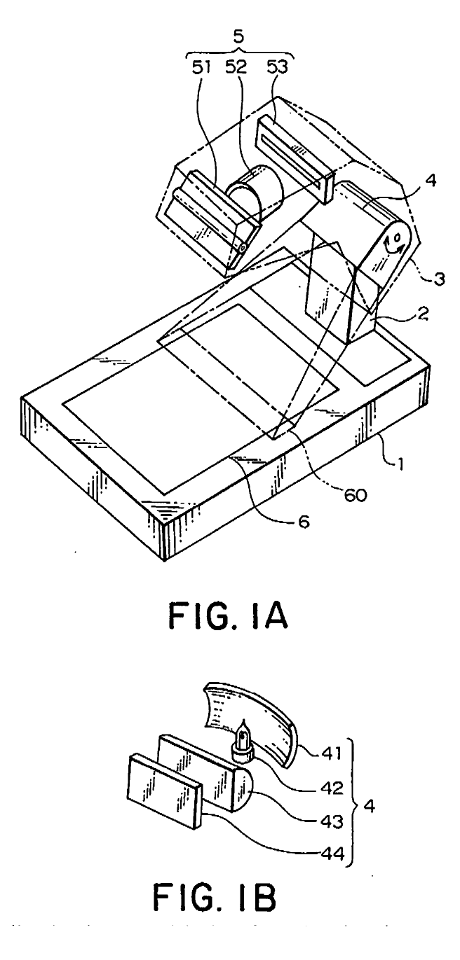

FIG. 1A is a perspective view showing the construction of the stand type image scanner according to the first embodiment, and FIG. 1B is a perspective view showing the construction of an exclusive light source portion of the stand type image scanner. In FIG. 1A, the interior of the stand type image scanner is conveniently illustrated as seen through a cover 3.

As shown in FIG. 1, this stand type image scanner comprises an exclusive light source portion 4 for illuminating an original 6 to be scanned, and a scanning portion 5 for scanning an original image by detecting reflected light from the original 6. The exclusive light source portion 4 and the scanning portion 5 are disposed so as to be spaced from the surface of the original by a fixed distance by a stand 2 of a supporting portion. In FIG. 1A, it is illustrated that the stand type image scanner and the original 6 are put on a table 1 such as a desk. Further, in FIG. 1A, the exclusive light source portion 4 and the scanning portion 5 in the apparatus are illustrated as seen through a cover 3, and other parts such as supporting members for the exclusive light source portion 4 and the scanning portion 5 are omitted from the illustration.

As shown in FIG. 1B, the exclusive light source portion 4 comprises a halogen lamp 42 serving as a light source, a concave mirror 41 disposed behind the halogen lamp 42, a cylindrical lens 43 disposed in front of the halogen lamp 42, and an optical filter 44 disposed in front of the cylindrical lens 43.

The light emitted from the halogen lamp 42 is reflected from the concave mirror 1, and converged at a desired angle in an irradiation direction by the cylindrical lens 43. Further, the light thus converged is subjected to wavelength selection for drop-out by the optical filter 44 as described later.

After the wavelength selection is carried out, the light of the exclusive light source is applied to a rectangular irradiation area 60 extending along the short sides of the original 6.

The scanning portion 5 comprises an auxiliary scanning mechanism 51, a lens 52 and a linear image sensor 53. The auxiliary scanning mechanism 51 is disposed above the center portion of the original 6 so as to look down the overall original 6 put on the table 1. The auxiliary scanning mechanism 51 scans the original 6 in the direction along the long sides of the original 6 corresponding to the auxiliary scanning direction. At this time, the irradiation area 60 based on the light of the exclusive light source is moved in the auxiliary scanning direction interlockingly with the scanning position of the auxiliary scanning mechanism 51.

An original image portion in the irradiation area 60 on the original is successively projected to the lens 52 by the auxiliary scanning mechanism 51. The light transmitted through the lens 52 is focused onto the surface of the linear image sensor 53. One or plural arrays of photoelectric converting elements are arranged in the linear image sensor 53. The linear image sensor 53 successively detects the reflected light and converts it from the original image portion in the irradiation area 60 to voltage values in the main scanning direction by the photoelectric converting elements.

Next, the wavelength selection of the optical filter 44 will be described.

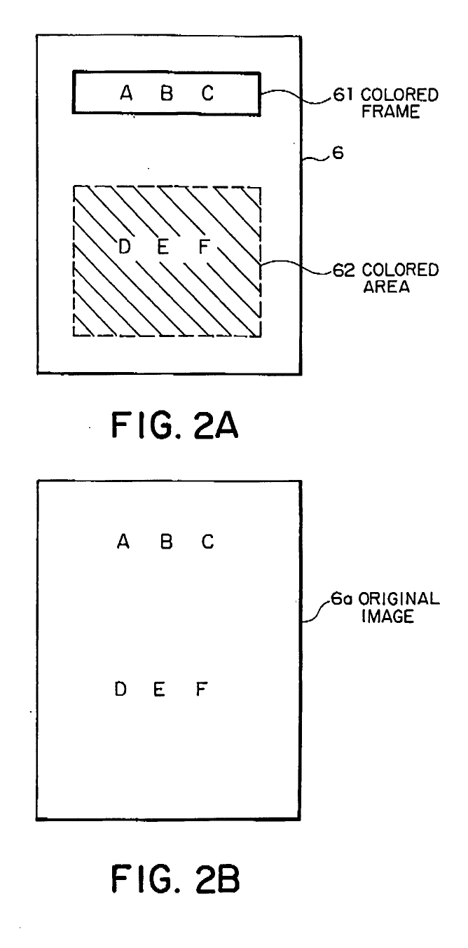

In the following description, there will be described a case where a colored frame 61 and a color area 62 other than characters are dropped out from the original 6 shown in FIG. 2A and only the characters from “A” to “F” are selectively scanned like an original image 6a shown in FIG. 2B.

In FIG. 2A, the colored area 62 is hatched for convenient description.

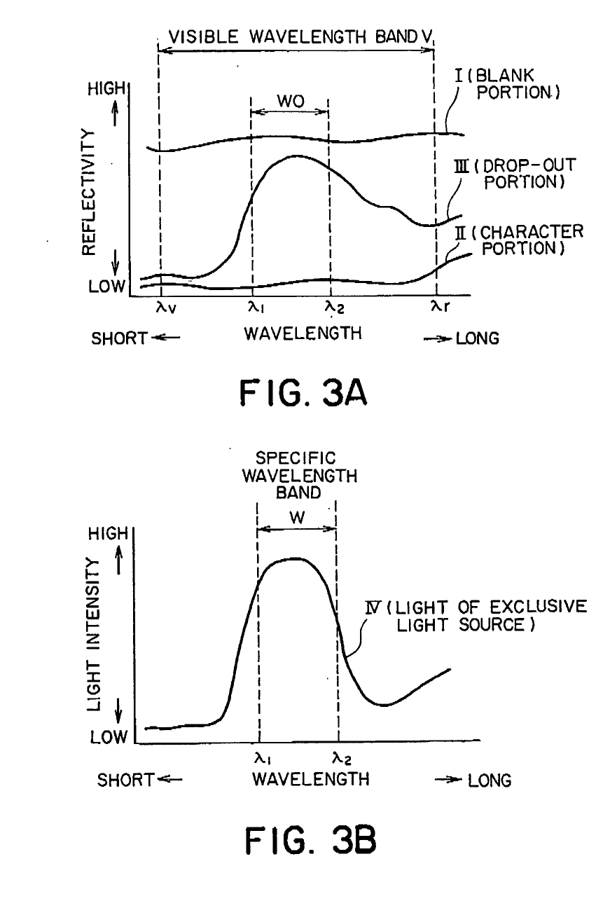

FIG. 3A is a graph showing the wavelength characteristic of reflectivity of each portion of the original 6. The curve I of the graph shows the wavelength characteristic of the reflectivity of a white blank portion on the original 6. The curve II of the graph shows the wavelength characteristic of the reflectivity of a black character portion on the original 6. The curve III shows the wavelength characteristic of the reflectivity of the colored frame 61 and the colored area 62 which are portions to be dropped out on the original 6.

The reflectivity of the white blank portion 4 has large values over the overall visible wavelength band V from the wavelength λv to λr as shown in the curve I. The reflectivity of the black character portion has small values over the visible wavelength band V as shown in the curve II.

On the other hand, in the wavelength band W0 from λ1 to λ2 within the overall visible wavelength band V, the reflectivity of the portions to be dropped out such as the colored frame 61, etc. has large values which are similar to those of the reflectivity at the blank portion. Further, in the wavelength band W0, the reflectivity of the portions to be dropped out is higher than that of portions which are not dropped out.

Therefore, the optical filter 44 selectively passes light having a specific wavelength band W within the wavelength band W0 in which the reflectivity of the portions to be dropped out is near to the reflectivity of the blank portion and the reflectivity of the portions not to be dropped out is smaller. In this embodiment, the specific wavelength band W is set to be equal to the wavelength band W0.

Herein, FIG. 3B is a graph showing the wavelength characteristic of the light of the exclusive light source which is transmitted through the optical filter 44. As shown by the curve IV in the graph, the light of the exclusive light source has higher light intensity in the specific wavelength band W from the wavelength λ1 to λ2. The values of the wavelengths λ1 and λ2 are set to 650 nm and 750 nm, respectively, when the color of the colored frame 61 and the colored area 62 to be dropped out is red, for example.

It is more preferable that the width of the specific wavelength band W is narrower than the width of the wavelength band W0 at the portion having high reflectivity, however, it may be equal to the wavelength band W0.

Accordingly, the light of the exclusive light source having the light intensity which is higher in the specific wavelength band W than that in the other wavelength band is applied to the original 6. As shown in FIG. 3A, the reflectivity of the blank portion is near to that of the portion to be dropped out in the specific wavelength band W. Therefore, the intensity of the reflected light from the portion to be dropped out can be set to the same level as that at the white portion such as the blank portion or the like.

The scanning portion 5 carries out the following binary processing. Namely, a value smaller than the detection value of the intensity of the reflected light from the portion to be dropped out is set as a reference value, and any portion on the original 6 at which the detection value of the reflected light intensity is higher than the reference value Is regarded as white while any portion on the original 6 at which the detection value of the reflected light intensity is smaller than the reference value is regarded as black. With this binary processing, the portion to be dropped out is scanned as white like the blank portion, etc. Namely, the colored frame 61 and the colored area 62 can be dropped out and only the character portion can be selectively scanned.

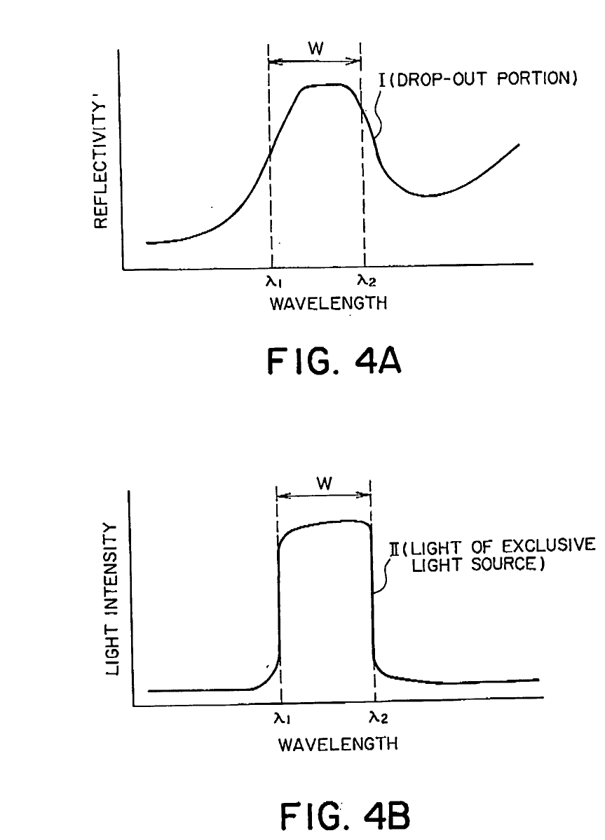

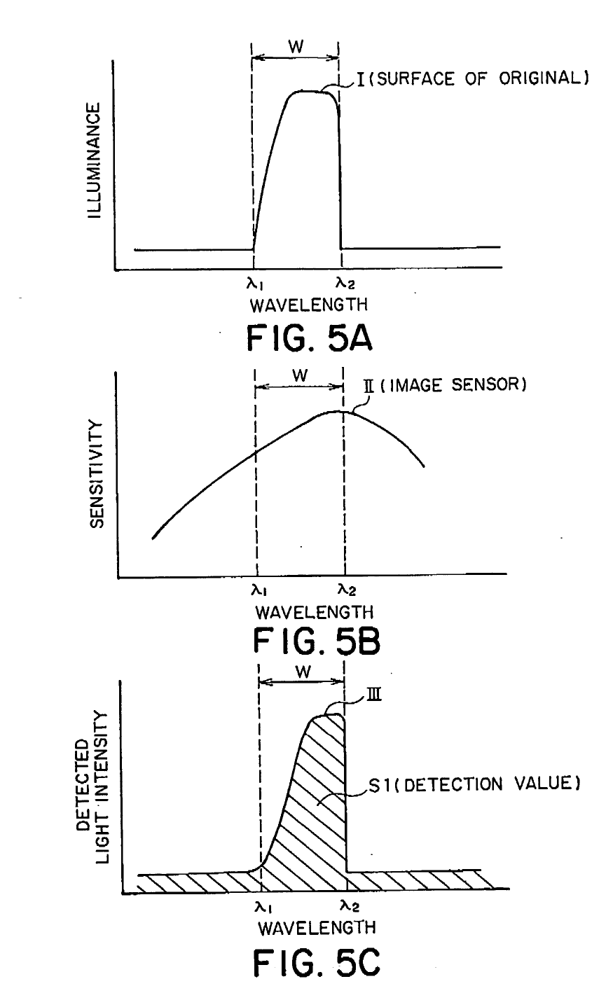

Next, an image scanning method of this embodiment will be described with reference to FIGS. 4A, 4B and FIGS. 5A to 5C.

FIG. 4A shows the wavelength characteristic of the reflectivity of the portion to be dropped out. As shown by the curve I of FIG. 4A, the reflectivity of the portion to be dropped out is higher in the specific wavelength band W from the wavelength λ1 to λ2. Therefore, as shown by the curve II of FIG. 4B, the light of the exclusive light source which selectively has higher light intensity in the specific wavelength band W is applied to the original.

As a result, the wavelength characteristic of the illuminance of the surface of the original is higher within only the specific wavelength band W as shown by the curve I of FIG. 5A.

Further, in general, the wavelength characteristic of the sensitivity of the linear image sensor is not uniform over the whole area of the visible wavelength band, and has a wavelength area having higher sensitivity and a wavelength area having lower sensitivity.

Here, FIG. 5B shows the wavelength characteristic of the linear image sensor 53 of the scanning portion 5. As shown by the curve II of FIG. 5B, the sensitivity of the linear image sensor 53 trends to increase in the specific wavelength band W as the wavelength is longer.

Accordingly, the detected light intensity of the linear image sensor 53 is relatively lower at the short wavelength side as compared with the illuminance of the original 6 as shown by the curve III of FIG. 5C.

The detected light intensity represented by the curve III over the whole visible wavelength band is output as the detection value of the reflected light intensity from the original 6, for example, as the output voltage. In the following description, the integration value of the detected light intensity in the whole visible wavelength band is output as the detection value. Namely, the area S1 of the hatched portion shown in FIG. 5C corresponds to the detection value.

Subsequently, a processor (not shown) of the scanning portion 5 carries out the binary processing of regarding as white a portion on the original at which the detection value of the reflected light intensity is higher than the reference value and regarding as black a portion on the original at which the detection value of the reflected light intensity is smaller than the reference value, whereby the portion to be dropped out is scanned as white like the blank portion and so on, thereby performing the selective drop-out operation.

In this embodiment, the reference value is set to a value which is smaller than the detection value of the reflected light intensity from the portion to the dropped out and higher than the detection value of the reflected light intensity from the portion not to be dropped out.

When the original image which has been subjected to binary processing is displayed, the colors of the white portion and the black portions are not necessarily limited to white and black, and they may be displayed with any colors through the image processing.

### Second Embodiment

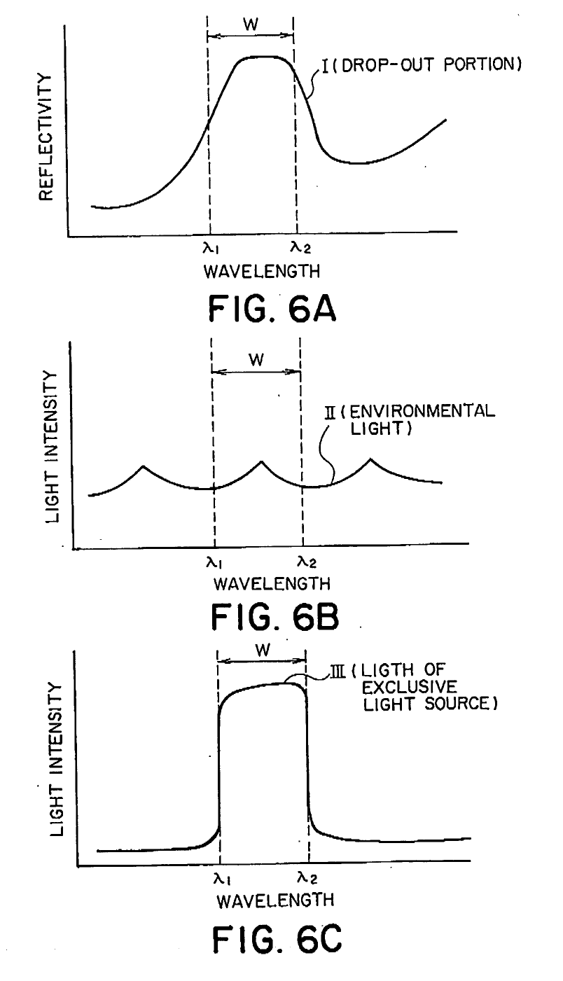

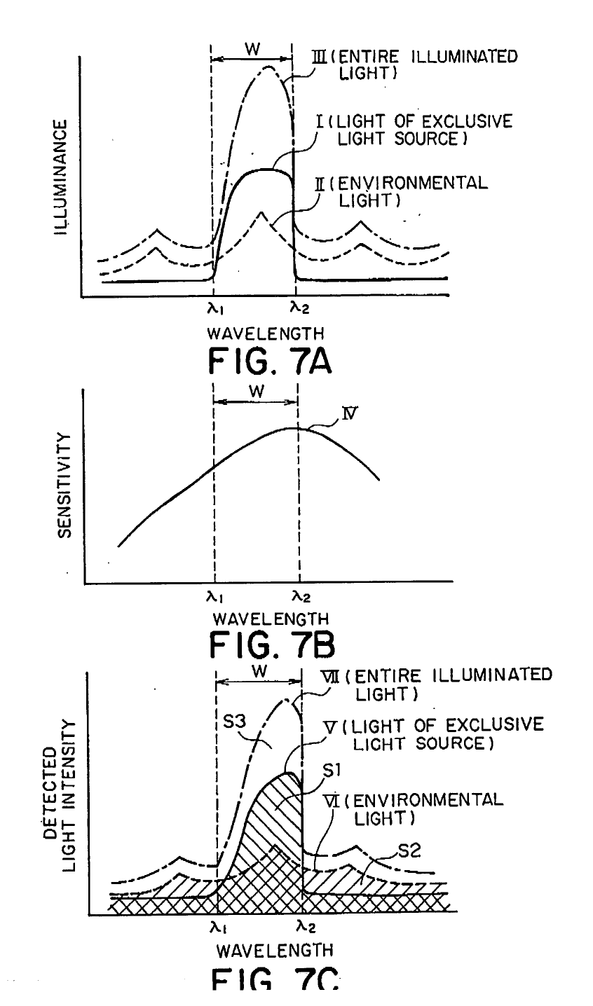

Next, a second embodiment of the present invention will be described with reference to FIGS. 6A to 6C and FIGS. 7A to 7C.

In the second embodiment, the detection value of the reflected light intensity when environmental light is applied to the original is recorded as an offset value in advance, and the binary processing described above is carried on the residual detection value obtained by subtracting the offset value from the detection value of the reflected light intensity when the light of the exclusive light source is applied.

Further, the construction of the second embodiment is the same as the scanning apparatus of the first embodiment shown in FIG. 1.

First, FIG. 6A is a graph showing the wavelength characteristic of the reflectivity of a portion to be dropped out. As shown by the curve I in FIG. 6A, the reflectivity of the portion to be dropped out is higher in the specific wavelength band W from the wavelength λ1 to λ2.

Therefore, the light of the exclusive light source which has selectively high light intensity In the specific wavelength band W as shown by the curve II of FIG. 6C is applied to the original.

In the stand type image scanner, the surrounding environmental light emitted from a ceiling lamp or the like is applied to the original 6 together with the light emitted from the exclusive light source portion 4.

FIG. 6B shows an example of the light intensity of the environmental light. As shown by the curve II of FIG. 6B, the environmental light has a light intensity above a fixed level in and out of the specific wavelength band W.

FIG. 7A shows the illuminance of light entering the linear image sensor 53 when the light of the exclusive light source or the environmental light is applied to the original. The curve I of FIG. 7A shows the illuminance when only the light emitted from the exclusive light source is applied to the original. The broken line II shows the illuminance based on the environmental light, and the one-dotted chain line of FIG. 7A shows the illuminance when both the light of the exclusive light source and the environmental light are applied.

The wavelength characteristic of the illuminance based on only the light of the exclusive light source shown by the curve I corresponds to the product of the wavelength characteristic of the reflectivity shown in FIG. 6A and the wavelength characteristic of the light intensity of the light of the exclusive light source shown in FIG. 6C. The wavelength characteristic of the illuminance based on only the environmental light shown by the broken line II corresponds to the product of the wavelength characteristic of the reflectivity shown in FIG. 6A and the wavelength characteristic of the light intensity of the environmental light shown in FIG. 6B. As shown by the one-dotted chain line III of FIG. 7A, the illuminance of the portion to be dropped out from the actual original is the sum of the illuminance shown by the curve I and the illuminance shown by the broken line II.

Next, FIG. 7C shows the detected light intensity in the image sensor. The curve V of FIG. 7C shows the detected light intensity when only the light of the exclusive light source is applied. The broken line VI shows the detected light intensity when only the environmental light is applied. Further, the one-dotted chain line VII shows the detected light intensity of all the illumination light including the light of the exclusive light source and the environmental light.

The wavelength characteristic of the detected light intensity when only the light of the exclusive light source shown by the curve V is applied corresponds to the product of the wavelength characteristic of the illuminance shown by the curve I and the wavelength characteristic of the sensitivity of the image sensor shown by the curve IV of FIG. 7B. The wavelength characteristic of the detected light intensity when only the environmental light is applied as shown by the broken line VI corresponds to the wavelength characteristic of the reflectivity shown by the broken line II and the wavelength characteristic of the sensitivity of the image sensor shown by the curve IV.

As shown by the one-dotted chain line VII of FIG. 7C, the detected light intensity of the reflected light from the portion to be dropped out on the actual original is the sum of the detected light intensity shown by the curve V and the detected light intensity shown by the broken line VI.

The detected light intensity over the whole visible wavelength band when all the illumination light shown by the one-dotted chain line VII is applied is output as the detection value of the reflected light intensity from the original 6, for example, as the voltage value. Namely, the area S3 corresponding to the sum of the area S1 of the portion hatched in the direction rising to the left and the area S2 of the portion hatched in the direction rising to the right is output as the detection value.

The processor (not shown) of the scanning portion 5 records as an offset value the detection value (area S2) of the reflected light intensity when only the environmental light is applied to the original as shown by the broken line of FIG. 7C. Thereafter, the binary processing is carried out on the residual detection value (the area S1) obtained by subtracting the offset value (area S2) from the detection value (area S3) of the reflected light intensity of the overall irradiation light. In this case, however, the reference value is set to a value smaller than the residual detection value in the binary processing.

The adverse effect of the environmental light can be removed by conducting the binary processing on the residual detection value obtained by subtracting the offset value as described above. Therefore, the stable drop-out processing can be performed irrespective of the environment in which the stand type image scanner is disposed.

### Third Embodiment

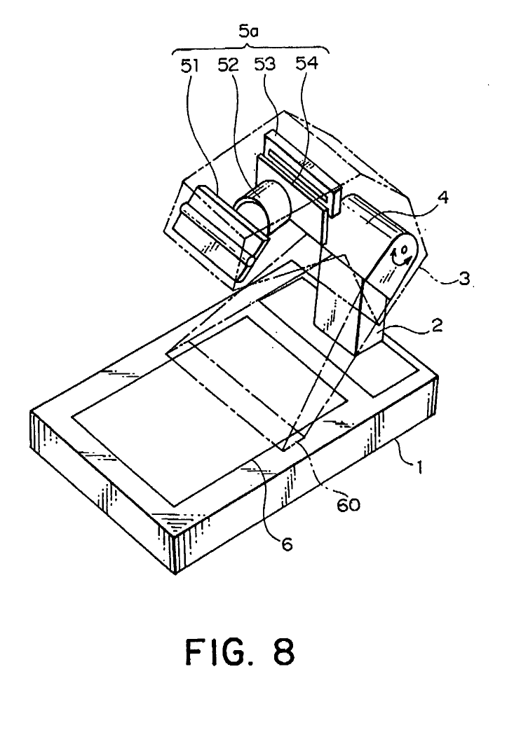

Next, a third embodiment according to the present invention will be described with reference to FIG. 8.

FIG. 8 is a perspective view showing the construction of a stand type image scanner according to a third embodiment of the present invention.

In the stand type image scanner of the third embodiment, an optical filter 54 for selectively transmitting light in a wavelength band in which the reflectivity is large at the portion to be dropped out is provided just in front of the linear image sensor 53 of the scanning portion 5a as shown in FIG. 8. The construction of parts other than the scanning portion 5a is the same as the first embodiment. The same parts as the first embodiment are represented by the same reference numerals and the detailed description thereof is omitted.

In this case, the transmissible wavelength characteristic of the optical filter 54 is coincident with the transmissible wavelength characteristic of the optical filter 44 of the exclusive light source portion shown in FIG. 1B.

The reflected light intensity in the specific wavelength band W in which the reflectivity is large at the portion to be dropped out can be detected as the detection value by detecting the intensity of light transmitted through the optical filter as the detection value. As a result, the detection value of the intensity of the reflected light from the portion to be dropped out can be set to the same level as the detection value of the intensity of reflected light from the white portion such as the blank or the like. Therefore, the drop-out processing can be performed more surely.

Further, by detecting the detected light intensity of the reflected light in only the specific wavelength band, the adverse effect of the environmental light can be reduced more greatly as compared with the case where the detection value due to the environmental light is not offset. Therefore, the stable drop-out processing can be realized irrespective of the environmental in which the stand type image scanner is disposed.

If the optical filter 54 of the scanning portion 5a is also changed when the optical filter 44 of the exclusive light source portion 4 is changed, the specific wavelength band can be easily set so as to be conformed with the wavelength characteristic of the reflectivity of the portion to be dropped out.

In the above-described embodiment, the present invention is constructed under a specific condition. However, according to the present invention, various modifications may be made to the above embodiment. For example, in the above embodiment, a pillar-shaped stand is provided as the supporting portion. However, the shape and construction of the supporting portion is not limited to the above embodiment. For example, the supporting portion may be designed in any shape and construction, such as a linear, bent or curved arm, a pipe frame, box frame, planar shape or the like. Further, the stand may be designed to have a hook shape in cross section so that it also serves as a regulating member for positioning the original.

Further, in the above embodiment, the original to be scanned as well as the stand type image scanner are put horizontally. However, the stand type image scanner does not necessarily need a table on which the original is put, and it may be used without keeping the space corresponding to the area of the original. For example, an arm may be provided to the stand type image scanner so that the original image is scanned while the original secured to the arm by a clamp is suspended.

Still further, in the above embodiment, the light is applied to the original in a slant direction to the surface of the original. However, the position of the exclusive light source portion of the present invention is not limited to this embodiment. For example, the scanning portion and the exclusive light source portion may be disposed above the center portion of the original.

In the above embodiment, the light is applied to the original by the exclusive light source portion while each part of the original is sequentially set as an irradiation area. However, the irradiation area of the present invention is not limited to this embodiment, and light may be applied to the whole surface of the original at the same time.

In the above embodiment, the wavelength character of the light of the exclusive light source is set by using the optical filter. However, the setting method of the wavelength characteristic is not limited to this embodiment, and any suitable method may be used.

In the above embodiment, the cylindrical lens is used in the exclusive light source portion, however, no cylindrical lens may be provided when the light source is sufficiently bright or when the light source is a rod-shaped fluorescent tube for emitting collimated light.

In the above embodiment, only one specific color is dropped out. However, in the present invention, plural specific colors may be dropped out. In this case, lights corresponding to colors to be dropped out may be emitted from exclusive light sources.

In the above embodiment, a specific color having only one peak in reflectivity is dropped out. When there are plural reflectivity peaks of the specific color, light which has large light intensity in the wavelength band of each peak is not necessarily required to be applied from an exclusive. For example, it is sufficient that the light intensity of the wavelength band corresponding to one of the plural peaks is large.

The above embodiment uses the auxiliary scanning mechanism in which the mirror is rotationally driven around the rotational shaft which is parallel to the arrangement direction of the photoelectric conversion elements of the linear image sensor. However, the auxiliary scanning mechanism of the present invention is not limited to this embodiment. For example, the mirror may be driven in parallel with keeping the position of the mirror in parallel to the linear image sensor.

As described above, according to the present invention, the exclusive light source portion is provided, and light in which the light intensity in the vicinity of the wavelength to be dropped out is selectively increased is applied from the exclusive light source portion, whereby the effect of the environmental light from the ceiling lamp or the like can be reduced even in the stand type image scanner, and the light having a desired wavelength characteristic can be applied from the exclusive light source to the original. Therefore, the reflected light intensity in the specific wavelength band at the portion to be dropped out can be set to the same level as the reflected light intensity of the white portion such as the blank portion or the like. As a result, the portion to be dropped out can be scanned as white like the blank portion or the like to thereby performing selective drop-out.

Accordingly, according to the present invention, the drop-out processing can be easily performed on even a thick original or originals put on file when the original images are scanned.

Further, if the reflected light intensity of environmental light from the original is recorded as an offset value and the residual detection value obtained by subtracting this offset value is subjected to the binary processing, the adverse effect of environmental light emitted from a ceiling lamp or the like can be removed even in the stand type image scanner. Therefore, the stable drop-out processing can be carried out irrespective of the environment under which the stand type image scanner is disposed or variation of environmental light.

While this invention has thus far been described in conjunction with the embodiments thereof, however, the present invention is not limited to these embodiments and it will readily be possible for those skilled in the art to put this invention into practice in various other manners.

What is claimed is:

1. A stand type image scanner comprising an exclusive light source portion for illuminating an original as a scanning object to be scanned and a scanning portion for detecting reflected light from the original to scan an original image, said scanning portion being arranged so as to be apart from said exclusive light source portion and the original;
wherein said exclusive light source portion applies light having a light intensity in a specific wavelength band within a wavelength band where the reflectivity of a portion to be dropped out on the original is high is higher than that in an unspecific wavelength band;
said scanning portion performing binary processing so as to regard a portion of the original where detection value of reflected light intensity is higher than a reference value as white color while regard a portion of the original where the detection value of the reflected light intensity is smaller than the reference value as black color.

2. A stand type image scanner as claimed in claim 1, wherein said scanning portion sets the reference value to a value smaller than the detection value of the reflected light intensity from the portion to be dropped out when the binary processing is carried out.

3. A stand type image scanner as claimed in claim 1, wherein the specific wavelength band is set to a wavelength band where the reflectivity of the portion to be dropped out is higher than that of a portion not to be dropped out.

4. A stand type image scanner as claimed in claim 3, wherein the reference value is set to a value higher than the detection value of the reflected light intensity from the portion not to be dropped out.

5. A stand type image scanner as claimed in claim 1, wherein said scanning portion records as an offset value the detection value of the reflected light intensity when environmental light is applied to the original, and with respect to a residual detection value obtained by subtracting the offset value from the detection value of the reflected light intensity when the light of the exclusive light source is applied, said scanning portion performs binary processing of regarding as white color a portion of the original at which the residual detection value is higher than a reference value and regarding as black color a portion of the original at which the residual detection value is smaller than the reference value.

6. A stand type image scanner as claimed in claim 5, wherein said scanning portion sets the reference value to a value smaller than the residual detection value.

7. A stand type image scanner as claimed in claim 1, wherein said exclusive light source portion has an optical filter for selectively transmitting light in the specific wavelength band, and the light transmitted through said optical filter is applied as the light of said exclusive light source.

8. A stand type image scanner as claimed in claim 1, wherein said scanning portion detects the reflected light intensity of the specific wavelength band as the detection value.

9. A stand type image scanner as claimed in claim 8, wherein said scanning portion has an optical filter for selectively transmitting light in the specific wavelength band, and the intensity of the light transmitted through said optical filter is detected as the detection value.

10. An image scanning method comprising the steps of:
when an original to be scanned is illuminated and reflected light from the original is detected to scan an original image, recording as an offset value the detection value of reflected light intensity when environmental light is applied to the original;
applying light of an exclusive light source having a light intensity in a specific wavelength band within a wavelength band where the reflectivity of a portion to be dropped out on the original is high is higher than that of an unspecific wavelength band;
calculating a residual detection value obtained by subtracting the offset value from the detection value of the reflected light intensity when the light of the exclusive light source is applied; and
performing binary processing of regarding as white color a portion of the original where the residual detection value is higher than a reference value and regarding as black color a portion of the original where the residual detection value is smaller than the reference value.
